(19) United States
(12) Patent Application Publication
(10) Pub. No.: US 2025/0042103 A1
(43) Pub. Date: Feb. 6, 2025

(54) METHOD FOR PRODUCING A THERMODEFORMABLE POLYMER/FIBRE COMPOSITE

(71) Applicant: BASF SE, Ludwigshafen am Rhein (DE)

(72) Inventors: Michael KALBE, Ludwigshafen am Rhein (DE); Rainer SCHEIDHAUER, Hassloch (DE); Sarunas TURCINSKAS, Ludwigshafen am Rhein (DE); Juergen BLAUL, Ludwigshafen am Rhein (DE); Marvin STEUBE, Ludwigshafen am Rhein (DE)

(21) Appl. No.: 18/718,851

(22) PCT Filed: Dec. 5, 2022
(86) PCT No.: PCT/EP2022/084444

§ 371 Date: Jun. 12, 2024

(30) Foreign Application Priority Data
Dec. 20, 2021 (EP) 21215947.9

(51) Int. Cl. B29C 70/12; B29C 70/40; B29K 311/10; B29L 7/00

(52) U.S. Cl. CPC B29C 70/12; B29C 70/40; B29K 2311/10; B29L 2007/008

(57) ABSTRACT

The invention relates to a process for producing a thermoformable polymer/fiber composite using an aqueous dispersion of a polymer P and a fibrous substrate, where the dispersion is obtained by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (M2), and
0% to 10% by weight of at least one further ethylenically unsaturated compound (M3) which is copolymerizable with monomers M1 and M2,
based in each case on the total amount of the monomers M,
in an aqueous medium in the presence of a polymer A or a polymer mixture A, where polymer A or polymer mixture A is formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amounts of monomers A add up to 100% by weight,
to the composites obtainable thereby, to the use thereof for production of polymer/fiber moldings, to the process for producing the moldings and to the moldings themselves, and to the aqueous polymer dispersion used in accordance with the invention and a process for production thereof.

The invention relates to a process for producing a thermoformable polymer/fiber composite using a polymer P polymerized in the presence of an acrylic acid copolymer. The invention also relates to the composites obtainable by the process of the invention, to the different uses thereof, to a process for producing polymer/fiber moldings by thermoforming the polymer/fiber composite, and to the resultant polymer/fiber moldings themselves.

Wood fiberboards are produced essentially proceeding from woodchips that are pretreated hydrothermally by means of steam, then treated under pressure and at temperatures above 140° C. and finally defibrated, likewise under pressure, in what are called refiners. Subsequently, the aqueous wood fiber pulp obtained is transferred into what is called the blowline, a tube having a much lower pressure, the effect of which is that the water evaporates and thus serves as a gaseous transport medium for the wood fibers through the blowline (hydropneumatic conveying). By additional blowing of heated dry air into the blowline, the wood fibers are dried and transported onward pneumatically. In order to assure very substantially uniform application of the aqueous binder required for production of the wood fiberboards to the fibers, the binder is sprayed into the blowline at one or more sites before the heated dry air is blown in. The “glued” fibers obtained after the drying are separated out and converted to a fiber web (fiber mat). This fiber mat is optionally compressed by means of a ‘cold’ preliminary compression and then pressed under pressure and at high temperature (150 to 230° C.) to give a wood-based material in slab form having a density of 250 to 1000 kg/m³ (“hot” consolidation). At the consolidation temperatures, a thermoset binder is formed from the binders such as formaldehyde resins, for example urea/formaldehyde, phenol/formaldehyde, melamine/formaldehyde, melamine/urea/formaldehyde or melamine/phenol/formaldehyde resins, or isocyanates such as methylene diisocyanate or toluidine diisocyanate. The use of thermally curable binders means that the wood fiberboards thus obtained are thermoset, i.e. no longer thermally deformable, after the “hot” consolidation.

WO 01/27163 teaches thermally curable polymer dispersions and the use thereof for production of thermoset polymer/fiber composites. One application is the production of wood fiberboards wherein the fibers are glued by the “blowline” method. The styrene acrylates used according to the teaching of WO 01/27163 are produced in the presence of polymers bearing carboxyl groups, the monomers of which are maleic anhydride, acrylic acid and acrylic/maleic esters with an ethoxylated oleylamine. This polymer bearing carboxyl groups is a comb polymer that has been produced in a polymer-analogous manner and has hydrophobic radicals that are at the same time thermally crosslinkable because of the amino radical. The product here too is thus a thermoset, i.e. is no longer deformable after thermal curing.

WO 2017/140520 teaches “glueing” of wood fibers in the blowline with a thermally non-crosslinking polymer dispersion and subsequent compression to fiberboards which, in spite of consolidation at high temperatures, are subsequently still deformable. The binders used according to this are styrene/methacrylate polymers that are obtained by polymerization in the presence of a polymer formed from 95 parts by weight of acrylic acid. The styrene/methacrylate polymer comprises 5% by weight of further copolymerized monomers. The shaped bodies obtained thereby are thermally deformable and nevertheless have good strength in everyday use. However, it is desirable for the water resistance thereof to be improved in order that the shaped bodies can also be used, for example, in wet rooms or in exterior applications.

It was therefore an object of the present invention to find a polymer/fiber composite that can be thermally formed to shaped bodies having both good mechanical strength and shape stability under moist climatic conditions.

The object is achieved in accordance with the invention by a process for producing a themoformable polymer/fiber composite using a polymer P and a fibrous substrate, where the latter are particles having a ratio of their longest extent to their shortest extent of at least 3, i.e. ≥3, preferably ≥5, where
the fibrous substrate is introduced into a gas stream, then
the fibrous substrate in the gas stream is contacted with an aqueous dispersion of a polymer P having a glass transition temperature T_{g}≥35 and ≤150° C. measured to DIN EN ISO 11357-2 (2013 September), then
the fibrous substrate that has been contacted with the aqueous dispersion of the polymer P is dried in the gas stream and then deposited, then
the deposited fibrous substrate obtained is converted to a fiber web, and then
the resultant fiber web is consolidated at a temperature≥the glass transition temperature T_{g} of polymer P to give the polymer/fiber composite, where the density of the polymer/fiber composite is increased by a factor of ≥3 compared to the corresponding fiber web,
wherein the aqueous dispersion of the polymer P is obtained by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (monomers M2), and
0% to 10% by weight of at least one further ethylenically unsaturated compound (monomer M3) which is copolymerizable with monomers M1 and M2,
based in each case on the total amount of the monomers M,
in an aqueous medium in the presence of a polymer A or a polymer mixture A, where polymer A or polymer mixture A is respectively formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amounts of monomers A add up to 100% by weight,
with the proviso that neither polymer A nor polymer mixture A is formed from an ester selected from the esters of ethylenically unsaturated monocarboxylic acids with amines having at least two hydroxyl groups, the monoesters and the diesters of ethylenically unsaturated dicarboxylic acids with amines having at least two hydroxyl groups.

The present invention additionally relates to the polymer/fiber composites obtainable by the process of the invention.

The present invention further relates to the use of the polymer/fiber composite for production of a polymer/fiber molding which differs in shape from the polymer/fiber composite used, and to the process for production thereof by heating the polymer/fiber composite up to a temperature above the glass transition temperature T_{g} of polymer P and converting it to the desired shape of the polymer/fiber molding at a temperature ≥T_{g} and then cooling the resultant polymer/fiber molding down to a temperature below the glass transition temperature T_{g} of polymer P while maintaining its shape. The present invention thus also relates to the polymer/fiber molding obtainable thereby and to the use thereof as a furniture molding, wall decor part or interior component in vehicle construction.

The present invention further relates to the aqueous dispersion of polymer P used in accordance with the invention and to a process for production thereof.

It is a characterizing feature of the process of the invention that a fibrous substrate is introduced into a gas stream. According to the invention, any fibrous substrates may be used. A fibrous substrate shall be understood here to mean those particles having a ratio of their longest extent to their shortest extent of at least 3, preferably ≥5, advantageously ≥10 and especially advantageously ≥50, and having a shortest extent of ≤2 mm, advantageously ≥0.001 and ≤0.5 mm and especially advantageously ≥0.001 and ≤0.1 mm. The shortest extent is determined here at an angle of 90° to the connecting line of the longest extent of the particles.

The fibrous substrates may be natural fibers, such as vegetable, animal and mineral fibers, or synthetic fibers made from natural or synthetic polymers. Examples of vegetable fibers are cotton fibers, flax fibers, hemp fibers, kenaf fibers, jute fibers, wood fibers or sisal fibers, examples of animal fibers are wool or other animal hair, an example of mineral fibers is rockwool, an example of synthetic fibers of natural origin is viscose fibers, and examples of synthetic fibers based on synthetic polymers are polyester fibers such as polytrimethylene terephthalate, polyethylene naphthalate, polyethylene terephthalate or polybutylene terephthalate fibers, and the different polycarbonate fibers, polyolefin fibers such as, in particular, polyethylene or polypropylene fibers, polyamide fibers such as polycaprolactam fibers (nylon-6), polyamide fibers formed from hexamethylenediamine and adipic acid (nylon-6,6), polyamide fibers formed from hexamethylenediamine and terephthalic acid (nylon-6T), polyamide fibers formed from para-phenylenediamine and terephthalic acid (aramid), and also mineral fibers, such as glass fibers, carbon fibers or basalt fibers. Advantageously, however, the invention uses natural fibers, especially of vegetable origin and especially advantageously wood fibers as obtained from a refiner in particular.

In the context of the present invention, a gas stream shall be understood to mean the directed transport of a gaseous substance along a pressure gradient, for example in a vessel or in a tube. In principle, it is possible to use all substances which are gaseous under the transport conditions (especially pressure and temperature). For example, organic and/or inorganic solvent vapors are used, such as, especially advantageously, water vapor or nitrogenous gas mixtures such as air in particular. Advantageously in accordance with the invention, water vapor/air mixtures are used in a broad mixing ratio.

According to the invention, the fibrous substrate in the gas stream is contacted with the aqueous dispersion of polymer P. If this contacting is effected in a blowline, advantageously via one or more injection nozzles, it should be ensured that the contacting in the blowline is effected, in flow direction, at one or more sites before the heated dry air for drying of the wood fibers is blown in.

Subsequently, the fibrous substrate that has been contacted with the aqueous dispersion of the polymer P is dried in the gas stream and then deposited. The drying of the fibrous substrate obtained is effected, for example, by removal and condensation of the water vapor or in a blowline by introduction of a sufficient amount of heated dry air that the relative air humidity in the resulting gas mixture is lowered to ≤10% or even ≤5%. This measure results in drying of the mixture of fibrous substrate and polymers P. In the context of this document, drying shall be understood to mean lowering of the residual moisture content of the substrate/polymer mixture to ≤15% by weight and advantageously to ≤10% by weight. In the context of this document, residual moisture content is understood to mean the percentage difference in weight, based on the substrate/polymer mixture used, which results when 1 g of substrate/polymer mixture is dried in a drying cabinet at 120° C. for one hour. The substrate/polymer mixture is separated out by the customary methods for separation of solids out of gas mixtures, for example by means of sieves or by exploitation of centrifugal forces via cyclone separators.

Subsequently, the separated-out substrate/polymer mixture obtained, in accordance with the invention, is converted to a fiber web, for example by appropriate scattering of the separated-out substrate/polymer mixture onto an area or, in continuous operation, onto a conveyor belt. This fiber web, optionally after mechanical pre-consolidation at a temperature well below, generally at least 10 kelvin below, the glass transition temperature T_{g} of polymer P, may have a thickness of ≥1 and ≤50 cm, advantageously ≥1 and ≤30 cm and especially advantageously ≥1 and ≤15 cm, and a density of ≥20 and ≤700 g/l, often ≥50 and ≤500 g/l and frequently ≥100 and ≤350 g/l.

Thereafter, the fiber web thus obtained is consolidated at a temperature≥the glass transition temperature T_{g} of polymer P to give a polymer/fiber composite. Consolidation here is understood to mean compression of the fiber web at this temperature under pressure to give a polymer/fiber composite. This increases the density of the polymer/fiber composite compared to the corresponding fiber web, depending on the fibrous substrate used, by a factor of ≥3 and advantageously by a factor of ≥6. In a corresponding manner, there is also a decrease in the thickness of the polymer/fiber composite compared to the corresponding fiber web. What is of significance in this connection is that the polymer/fiber composite of the invention advantageously has a two-dimensional flat shape. It will be appreciated that the polymer/fiber composite of the invention may alternatively—depending on the press mold chosen—have any desired non-flat three-dimensional forms.

What is essential to the process is that the inventive aqueous dispersion of polymer P is used. The present invention thus also relates to an aqueous dispersion of polymer P obtainable by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (M2), and
0% to 10% by weight of at least one further ethylenically unsaturated compound (M3) which is copolymerizable with monomers M1 and M2,
based in each case on the total amount of the monomers M,
in an aqueous medium in the presence of a polymer A or a polymer mixture A, where polymer A or polymer mixture A is respectively formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amounts of monomers A add up to 100% by weight,
with the proviso that neither polymer A nor polymer mixture A is formed from an ester selected from the esters of ethylenically unsaturated monocarboxylic acids with amines having at least two hydroxyl groups, the monoesters and the diesters of ethylenically unsaturated dicarboxylic acids with amines having at least two hydroxyl groups.

It is essential to the process that the aqueous dispersion of polymer P is produced by free-radically initiated emulsion polymerization of a composition of ethylenically unsaturated monomers M (monomers M) in an aqueous medium in the presence of a polymer A or a polymer mixture A, where polymer A and polymer mixture A are respectively formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amount of monomers A add up to 100% by weight.

Where monomers having carboxylic acid radicals are mentioned in the context of this application, this always also includes the water-soluble salts thereof, for example the sodium salts, potassium salts or ammonium salts.

A polymer mixture A is understood here to mean that there are two or more polymers formed from monomers A1, A2 and A3, wherein the total amount of monomers has the inventive ratio. It is thus possible, for example, that the acrylic acid content of one polymer is greater than 70% by weight, provided that the acrylic acid content of the other polymer is lower and the total proportions are satisfied.

Useful monomers as at least one monomer A3 for production of polymer A used in accordance with the invention and of polymer mixture A are especially ethylenically unsaturated compounds that are free-radically copolymerizable with monomers A1 and A2 in a simple manner, for example ethylene, vinylaromatic monomers such as styrene, α-methylstyrene, o-chlorostyrene or vinyltoluenes, vinyl halides such as vinyl chloride or vinylidene chloride, esters derived from vinyl alcohol and from monocarboxylic acids having 1 to 18 carbon atoms, for example vinyl acetate, vinyl propionate, vinyl n-butyrate, vinyl laurate, and vinyl stearate, esters derived from α,β-monoethylenically unsaturated mono- and dicarboxylic acids having preferably from 3 to 6 carbon atoms, particular examples being acrylic acid, methacrylic acid, maleic acid, fumaric acid, and itaconic acid, with alkanols generally having 1 to 12, preferably 1 to 8 and especially 1 to 4 carbon atoms, particular examples being the methyl, ethyl, n-butyl, isobutyl, pentyl, hexyl, heptyl, octyl, nonyl, decyl, and 2-ethylhexyl esters of acrylic and of methacrylic acid, the dimethyl or di-n-butyl esters of fumaric and of maleic acid, nitriles of α,β-monoethylenically unsaturated carboxylic acids, for example acrylonitrile, methacrylonitrile, fumaronitrile, maleonitrile, and also C₄₋₈-conjugated dienes, such as 1,3-butadiene (butadiene) and isoprene. The monomers mentioned are generally the main monomers, and these combine to form a proportion of ≥50% by weight, preferably ≥80% by weight and especially preferably ≥90% by weight, based on the entirety of monomers A3, or indeed form the entirety of monomers A3. The solubility of these monomers in water under standard conditions [20° C., 1 atm (absolute)] is very generally only moderate to low.

Monomers A3 which have higher water solubility under the abovementioned conditions are those which comprise either at least one sulfo group and/or anion corresponding thereto or at least one amino, amido, ureido, or N-heterocyclic group, and/or nitrogen-protonated or -alkylated ammonium derivatives thereof. Examples include acrylamide and methacrylamide, and also vinylsulfonic acid, 2-acrylamido-2-methylpropanesulfonic acid, styrenesulfonic acid, and water-soluble salts thereof, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl) methacrylamide, and 2-(1-imidazolin-2-onyl)ethyl methacrylate. The abovementioned water-soluble monomers A3 are usually present merely as modifying monomers in amounts of ≤10% by weight, preferably ≤5% by weight and especially preferably ≤3% by weight, based on the entirety of monomers A3.

Advantageously, the polymers A are, or the polymer mixture A is, prepared by using, as monomers A3, only those monomer mixtures which comprise
90% to 100% by weight of esters of acrylic and/or methacrylic acid with alkanols having 1 to 12 carbon atoms, or
90% to 100% by weight of styrene and/or butadiene, or
90% to 100% by weight of vinyl acetate, vinyl propionate and/or ethylene.

According to the invention, the copolymerized proportion of monomers A3 in polymer A or polymer mixture A is 0% to 5% by weight, advantageously ≤3% by weight or ≤1% by weight and ≥0.1% by weight.

In a further advantageous embodiment, polymer A or polymer mixture A does not comprise any monomers A3 in copolymerized form. Accordingly, polymer A or polymer mixture A is formed to an extent of ≥95% by weight, advantageously to an extent of ≥97% by weight or ≥99% by weight and, in a further embodiment, to an extent of 100% by weight of monomers A1+A2 in copolymerized form.

If a polymer mixture A is used in accordance with the invention, this can be obtained by standard combining of two polymers A, each formed from acrylic acid (monomer A1) and maleic acid and/or maleic anhydride (monomer A2), and optionally monomers A3. In the case of the polymer mixture, the mixture includes the monomer composition of the invention.

The polymers A used in accordance with the invention are generally prepared by free-radically initiated polymerization of the monomers A in an aqueous medium. Advantageously, the polymers A are prepared in the presence of at least one free-radical chain transfer agent, particular preference being given to sulfur-, nitrogen- and/or phosphorus-containing free-radical chain transfer agents having a solubility of >5 g/100 g of water in deionized water at 20° C. and 1 atm.

The principles underlying the preparation of the polymers A are familiar to the person skilled in the art (see by way of example A. Echte, Handbuch der Technischen Polymerchemie [Handbook of Industrial Polymer Chemistry], chapter 6, VCH, Weinheim, 1993 or B. Vollmert, Grundriss der Makromolekularen Chemie [Principles of Macromolecular Chemistry], vol. 1, E. Vollmert Verlag, Karlsruhe, 1988).

Sulfur-containing free-radical chain transfer agents used are, for example, mercaptoalkanols such as 2-mercaptoethanol, 2-mercaptopropanol or 3-mercaptopropanol, alkali metal hydrogensulfites such as sodium hydrogensulfite or potassium hydrogensulfite, and thiosulfuric acid and the alkali metal salts thereof or 3-mercapto-2-aminopropanoic acid (cysteine), nitrogen-containing free-radical chain transfer agents used are, for example, hydroxylamine (ammonium) compounds such as hydroxylammonium sulfate, and phosphorus-containing free-radical chain transfer agents used are, for example, phosphorous acid, hypophosphorous acid, metaphosphorous acid, orthophosphoric acid, pyrophosphoric acid or polyphosphoric acid and the alkali metal salts thereof, especially the sodium or potassium salts thereof, advantageously sodium hypophosphite or sodium dihydrogenphosphate.

Especially advantageously, the free-radical chain transfer agent is selected from hypophosphorous acid and the alkali metal salts thereof, especially sodium hypophosphite, alkali metal hydrogensulfites, especially sodium hydrogensulfite, hydroxylammonium sulfate and/or 2-mercaptoethanol.

In the preparation of the polymers A, it is advantageous when the amount of the free-radical chain transfer agent is chosen such that the weight-average molecular weight of the polymers A is ≥1000 and ≤20 000 g/mol and especially advantageously ≥2000 and ≤20 000 g/mol. The required amount of the free-radical chain transfer agent and the corresponding polymerization conditions are known to the person skilled in the art or can be ascertained by such a person in simple routine tests.

In a preferred embodiment, polymer A has a weight-average molecular weight Mw of ≥1000 and ≤20 000 g/mol.

In a particular embodiment, a polymer mixture A is chosen that comprises and especially consists of
10% to 30% by weight of a polymer A having a weight-average molecular weight of >7000 and <20 000 g/mol (polymer A1) and
70% to 90% by weight of a polymer A having a weight-average molecular weight of 1000 to 5000 g/mol (polymer A2),
based on the total amount of polymer mixture A.

Polymer A1 and polymer A2 thus differ in their average molecular weight and may additionally differ in their composition of monomers A1, A2 and A3, where the total amount of all monomers has the composition of the invention.

The weight-average molecular weights of polymers A are determined in a manner familiar to the person skilled in the art according to DIN EN ISO 13885-3 by gel permeation chromatography with a polyacrylic acid sodium salt as standard.

Where the term “polymer (mixture) A” is used hereinafter, this is intended to express that this means both polymer A and polymer mixture A.

In the preparation of the polymer P used in accordance with the invention, it is optionally possible to initially charge a portion or the entirety of polymer (mixture) A in the aqueous polymerization medium. Alternatively, it is possible to meter in the entirety or any remaining residual amount of polymer (mixture) A together with the monomers M during the polymerization reaction. The manner in which the entirety or any remaining residual amount of polymer (mixture) A is metered into the aqueous polymerization medium here can be discontinuous in one or more portions, or continuous with constant or varying flow rates. Advantageously, the entirety of polymer (mixture) A is initially charged in the aqueous polymerization medium prior to triggering the polymerization reaction of the monomers M. In a further advantageous embodiment, the polymer (mixture) A is prepared “in situ” in the polymerization medium for the polymerization of the monomers M.

What is important is that the aqueous polymerization medium, in the preparation of the polymer P, as well as the polymer (mixture) A, may additionally also comprise dispersing aids which keep both the monomer droplets and the dispersion particles of the polymer P obtained by the free-radically initiated polymerization of the monomers M dispersed in the aqueous phase and hence ensure the stability of the aqueous polymer composition produced. These may be the protective colloids typically used in the performance of free-radical aqueous emulsion polymerizations or they may be emulsifiers.

Suitable protective colloids are, for example, polyvinyl alcohols, cellulose derivatives or copolymers comprising vinylpyrrolidone. A detailed description of further suitable protective colloids is given in Houben-Weyl, Methoden der organischen Chemie [Methods of Organic Chemistry], vol. XIV/1, Makromolekulare Stoffe [Macromolecules], pages 411-420, Georg-Thieme-Verlag, Stuttgart, 1961. Since the polymer (mixture) A used in accordance with the invention can also act as a protective colloid, it is advantageous in accordance with the invention not to use any additional protective colloids.

It is of course also possible to use mixtures of emulsifiers and/or protective colloids. Such emulsifiers are familiar to the person skilled in the art and are described, for example, in WO 2017/140520 on pages 9 and 10.

If dispersing aids are included in the preparation of the aqueous dispersion of the polymer P, the total amount of dispersing aids used, especially emulsifiers, is 0.1% to 5% by weight, preferably 1% to 3% by weight, based in each case on the total amount of the monomers M (total amount of monomers M). In an advantageous embodiment, emulsifiers are used as the sole dispersing aids.

If dispersing aids are included in the preparation of the aqueous dispersion of the polymer P, it is optionally possible to initially charge a portion or the entirety of the dispersing aids as a constituent of the aqueous medium comprising the polymer (mixture) A. Alternatively, it is possible to meter in the entirety or any remaining residual amount of dispersing aids together with the monomers M during the polymerization reaction. The manner in which the entirety or any remaining residual amount of dispersing aids is metered into the aqueous polymerization medium here can be discontinuous in one or more portions, or continuous with constant or varying flow rates.

In a preferred embodiment, the amount of polymer A is chosen such that the ratio of the amount of polymer A to the total amount of monomers M is in the range from 10:90 to 50:50, preferably in the range from 20:80 to 40:60.

In a likewise preferred embodiment, the amount of polymer mixture A is chosen such that the ratio of the amount of polymer mixture A to the total amount of monomers M is in the range from 10:90 to 50:50, preferably in the range from 20:80 to 40:60.

It is essential to the invention that a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (M2), and
0% to 10% by weight of at least one other ethylenically unsaturated compound (M3) which is copolymerizable with monomers M1 and M2,
based in each case on the total amount of monomers M, is polymerized by free-radical emulsion polymerization to give a polymer P, where polymer P has a glass transition temperature T_{g} of ≥35 and ≤150° C., preferably of ≥60 and ≤90° C., measured to DIN EN ISO 11357-2 (2013 September).

The performance of free-radically initiated emulsion polymerizations of ethylenically unsaturated compounds (monomers) in an aqueous medium has already been widely described and is therefore well known to those skilled in the art [see e.g. “Emulsionspolymerisation” [Emulsion polymerization] in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, “Chemie in unserer Zeit” [Chemistry in our time] 24, pages 135-142 (1990); Emulsion Polymerisation, Interscience Publishers, New York (1965); DE-A 40 03 422 and “Dispersionen synthetischer Hochpolymerer” [Dispersions of Synthetic High Polymers], F. Hölscher, Springer-Verlag, Berlin (1969)]. The free-radically initiated aqueous emulsion polymerization is typically carried out by dispersing the monomers in an aqueous medium, generally by means of dispersing aids such as emulsifiers and/or protective colloids, and polymerizing them using at least one water-soluble free-radical polymerization initiator. It is frequently the case that the residual contents of unreacted monomers in the resulting aqueous polymer dispersions are reduced using chemical and/or physical methods likewise known to those skilled in the art [see for example EP-A 771328, DE-A 19624299, DE-A 19621027, DE-A 19741184, DE-A 19741187, DE-A 19805122, DE-A 19828183, DE-A 19839199, DE-A 19840586, and 19847115], the polymer solids content is adjusted to a desired value by diluting or concentrating, or further customary additives, for example foam- or viscosity-modifying additives, are added to the aqueous polymer dispersion. The production of an aqueous dispersion of polymer P used in accordance with the invention differs from this general procedure merely in that the monomers M are polymerized in the presence of at least one polymer A or polymer mixture A. It will be appreciated here that, for preparation of the polymers P, the scope of the present document is also to include the seed, staged and gradient modes of polymerization that are familiar to the person skilled in the art.

Advantageously, esters of acrylic acid with alkanols having 2 to 8 carbon atoms (monomers M1) chosen are ethyl acrylate, n-butyl acrylate, isobutyl acrylate, pentyl acrylate, hexyl acrylate, heptyl acrylate, octyl acrylate and 2-ethylhexyl acrylate.

In the case of esters of alcohols of biological origin, it is possible to increase the “biocarbon content” of polymer P. Suitable alcohols for the acrylic esters (M1) are, for example, isobutanol, isopentanol and 2-octanol. A proportion of biocarbon elevated in this way reduces the proportion of fossil carbon and lowers the requirement for CO₂ in the production of the polymer dispersion.

The term “biocarbon” suggests that the carbon is of biological origin and comes from a biomaterial/renewable raw materials. A renewable raw material or biomaterial is an organic material in which the carbon comes from the CO₂ that has been recently (on the human scale) fixed from the atmosphere by photosynthesis. A biomaterial (100% carbon of natural origin) has an isotope ratio of ¹⁴C/¹²C of greater than 10⁻¹², typically about 1.2×10⁻¹², while a fossil material has a ratio of zero. In fact, the ¹⁴C isotope is formed in the atmosphere and then incorporated by photosynthesis, over a period of a few decades. The half-life of ¹⁴C is 5730 years. Thus, materials that come from photosynthesis, generally plants, necessarily have a maximum content of the ¹⁴C isotope. The content of biomaterial or biocarbon can be determined according to standards ASTM D 6866-12, Method B (ASTM D 6866-06) and ASTM D 7026 (ASTM D 7026-04).

In a preferred embodiment, monomer M1 is selected from ethyl acrylate, propyl acrylate, n-butyl acrylate, i-butyl acrylate, hexyl acrylate and 2-ethylhexyl acrylate.

According to the invention, monomers M2 are styrene and/or methyl methacrylate.

Monomers M3 are ethylenically unsaturated compounds that are copolymerizable with monomers M1 and M2. Useful monomers of this kind are especially monomers that are free-radically polymerizable in a simple manner, for example ethylene, vinylaromatic monomers such as α-methylstyrene, o-chlorostyrene or vinyltoluenes, vinyl halides such as vinyl chloride or vinylidene chloride, esters derived from vinyl alcohol and from monocarboxylic acids having 1 to 18 carbon atoms, for example vinyl acetate, vinyl propionate, vinyl n-butyrate, vinyl laurate, and vinyl stearate, esters derived from α,β-monoethylenically unsaturated dicarboxylic acids having preferably 3 to 6 carbon atoms, such as, in particular, maleic acid, fumaric acid, and itaconic acid, with alkanols generally having 1 to 12, preferably 1 to 8 and especially 1 to 4 carbon atoms, such as, in particular, the dimethyl or di-n-butyl esters of fumaric and of maleic acid, nitriles of α,β-monoethylenically unsaturated carboxylic acids, for example acrylonitrile, methacrylonitrile, fumaronitrile, maleonitrile, and also C₄₋₈ conjugated dienes, such as 1,3-butadiene and isoprene.

Monomers M3 that modify the polymer are those that contain either at least one acid group and/or anion corresponding thereto or at least one amino, amido, ureido, or N-heterocyclic group and/or nitrogen-protonated or nitrogen-alkylated ammonium derivatives thereof. Examples include α,β-monoethylenically unsaturated mono- and dicarboxylic acids and amides thereof, e.g. acrylic acid, methacrylic acid, maleic acid, fumaric acid, itaconic acid, acrylamide, and methacrylamide, and also vinylsulfonic acid, 2-acrylamido-2-methylpropanesulfonic acid, styrenesulfonic acid, and water-soluble salts thereof, and also N-vinylpyrrolidone, 2-vinylpyridine, 4-vinylpyridine, 2-vinylimidazole, 2-aminoethyl acrylate, 2-aminoethyl methacrylate, 2-aminopropyl acrylate, 2-aminopropyl methacrylate, 3-aminopropyl acrylate, 3-aminopropyl methacrylate, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl) methacrylamide and 2-(1-imidazolin-2-onyl)ethyl methacrylate.

These aforementioned monomers M3 may be present as modifying monomers. If present, they are used in amounts of ≤10% by weight and preferably ≤5% by weight, based on the total amount of monomers P.

Monomers M3 that typically increase the internal strength of the films formed by a polymer matrix normally have at least one epoxy, hydroxyl, N-methylol or carbonyl group, or at least two non-conjugated ethylenically unsaturated double bonds. Examples thereof include monomers having two vinyl radicals, monomers having two vinylidene radicals, and monomers having two alkenyl radicals. Particularly advantageous here are diesters of dihydric alcohols with α,β-monoethylenically unsaturated monocarboxylic acids, preference among these being given to acrylic and methacrylic acid. Examples of monomers of this type having two non-conjugated ethylenically unsaturated double bonds are alkylene glycol diacrylates and alkylene glycol dimethacrylates, for example ethylene glycol diacrylate, propylene 1,2-glycol diacrylate, propylene 1,3-glycol diacrylate, butylene 1,3-glycol diacrylate, butylene 1,4-glycol diacrylate and ethylene glycol dimethacrylate, propylene 1,2-glycol dimethacrylate, propylene 1,3-glycol dimethacrylate, butylene glycol 1,3-dimethacrylate, butylene glycol 1,4-dimethacrylate, and also 1,2-, 1,3- or 1,4-divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. Other materials of particular significance in this context are the C₁-C₈-hydroxyalkyl esters of methacrylic and of acrylic acid, for example 2-hydroxyethyl, 2-hydroxypropyl or 3-hydroxy- or 4-hydroxybutyl acrylate and the corresponding methacrylate, and also compounds such as diacetoneacrylamide and acetylacetoxyethyl acrylate or methacrylate. Frequently, the aforementioned monomers are used in amounts of ≤5% by weight, but preferably in amounts ≤1% by weight, based in each case on the total amount of monomers P.

Polymer P is preferably obtainable by free-radically initiated emulsion polymerization of a monomer composition composed of
5% to 30% by weight of one or more monomers M1 selected from esters of acrylic and/or methacrylic acid with alkanols having 2 to 8 carbon atoms, especially esters of acrylic acid with alkanols having 2 to 8 carbon atoms,
70% to 95% by weight or 70% to 94.9% by weight of styrene and/or methyl methacrylate (M2),
0.1% to 10% by weight of at least one further ethylenically unsaturated compound (M3) which is copolymerizable with monomers M1 and M2, of which 0.1% to 5.0% by weight, based on total monomers M, is glycidyl acrylate and/or glycidyl methacrylate,
based in each case on the total amount of the monomers M.

Polymer P is more preferably obtainable by free-radically initiated emulsion polymerization of a monomer composition composed of
5% to 25% by weight of ethyl acrylate, propyl acrylate, n-butyl acrylate, i-butyl acrylate, hexyl acrylate and/or 2-ethylhexyl acrylate (M1),
70% to 94.9% by weight of styrene and/or methyl methacrylate (M2),
0.1% to 5.0% by weight of glycidyl acrylate and/or glycidyl methacrylate (M3a),
0% to 5.0% by weight of acrylic acid, methacrylic acid, 2-hydroxyethyl acrylate, 2-hydroxypropyl acrylate and/or 3-hydroxypropyl acrylate and/or methacrylate (M3b),
0% to 2.0% by weight of butylene 1,4-glycol diacrylate and -methacrylate, 1,2-, 1,3- and 1,4-divinylbenzene, allyl acrylate and/or allyl methacrylate (M3c),
where the amounts of monomers M add up to 100% by weight.

Polymer P is more preferably obtainable by free-radically initiated emulsion polymerization of a monomer composition composed of
5% to 20% by weight of ethyl acrylate, propyl acrylate, n-butyl acrylate, i-butyl acrylate, hexyl acrylate and/or 2-ethylhexyl acrylate (M1),
70% to 94.9% by weight of styrene and/or methyl methacrylate (M2),
0.1% to 5.0% by weight of glycidyl acrylate and/or glycidyl methacrylate (M3a),
0% to 5.0% by weight of acrylic acid, methacrylic acid, 2-hydroxyethyl acrylate, 2-hydroxypropyl acrylate and/or 3-hydroxypropyl acrylate and/or 2-hydroxyethyl methacrylate, 2-hydroxypropyl methacrylate and/or 3-hydroxypropyl methacrylate (M3b),
0% to 2.0% by weight of butylene 1,4-glycol diacrylate and -methacrylate, 1,2-, 1,3- and 1,4-divinylbenzene, allyl acrylate and/or allyl methacrylate (M3c),
where the amounts of monomers M add up to 100% by weight.

The free-radically initiated aqueous emulsion polymerization for preparation of the polymers P is generally conducted in the presence of 0.1% to 5% by weight, preferably 0.1% to 4% by weight and especially 0.1% to 3% by weight, based in each case on the total amount of monomers M, of a free-radical polymerization initiator (free-radical initiator). Suitable free-radical initiators are all initiators that are capable of triggering a free-radical aqueous emulsion polymerization. These may in principle be peroxides or they may be azo compounds. Redox initiator systems are of course also suitable. Peroxides used may in principle be inorganic peroxides, such as hydrogen peroxide or peroxodisulfates, such as the monoalkali metal or dialkali metal or ammonium salts of peroxodisulfuric acid, for example the monosodium and disodium, monopotassium and dipotassium or ammonium salts thereof, or organic peroxides such as alkyl hydroperoxides, for example tert-butyl hydroperoxide, p-menthyl hydroperoxide or cumyl hydroperoxide, and also dialkyl or diaryl peroxides, such as di-tert-butyl peroxide or dicumyl peroxide. Azo compounds used are primarily 2,2′-azobis(isobutyronitrile), 2,2′-azobis(2,4-dimethylvaleronitrile), and 2,2′-azobis(amidinopropyl)dihydrochloride (AIBA, corresponds to V-50 from Wako Chemicals). It is of course also possible to use so-called redox initiator systems as free-radical initiators. Suitable oxidants for redox initiator systems are essentially the peroxides mentioned above. Corresponding reductants that may be used are sulfur compounds in a low oxidation state such as alkali metal sulfites, for example potassium and/or sodium sulfite, alkali metal hydrogensulfites, for example potassium and/or sodium hydrogensulfite, alkali metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides, such as sorbose, glucose, fructose and/or dihydroxyacetone.

As well as the seed-free mode of preparation, the polymer particle size can also be adjusted by effecting the emulsion polymerization for preparation of the polymers P by the seed latex process or in the presence of a seed latex produced in situ. Such processes are known to those skilled in the art and can be found in the prior art (see e.g. EP-B 40 419, EP-A 567 812, EP-A 614 922 and “Encyclopedia of Polymer Science and Technology”, vol. 5, page 847, John Wiley & Sons Inc., New York, 1966). For instance, the prior art recommends, in the semicontinuous feed process, initially charging a defined finely divided seed polymer dispersion in the aqueous polymerization medium and then polymerizing the monomers M in the presence of the seed latex. In this case, the seed polymer particles act as ‘polymerization seeds’ and decouple the polymer particle formation and polymer particle growth. During the emulsion polymerization, it is possible in principle to add further seed latex directly to the aqueous polymerization medium. This achieves broad size distributions of the polymer particles, which are often desirable especially in the case of polymer dispersions having a high solids content (in this regard, cf., for example, DE-A 4213965). Rather than the addition of a defined seed latex, it can also be produced in situ. For this purpose, for example, a portion of the monomers P used for polymerization and of the free-radical initiator is initially charged together with a portion or the entirety of the polymer A and optionally additional dispersing aids and heated to reaction temperature, forming a relatively finely divided polymer seed. Subsequently, in the same aqueous polymerization medium, the actual polymerization is conducted by the feed method (see also DE-A 4213965).

Advantageously, the polymers P are prepared by free-radically initiated aqueous emulsion polymerization at a reaction temperature in the range from 0 to 170° C., but particular preference is given to temperatures of 70 to 120° C. and especially 80 to 100° C. The free-radical aqueous emulsion polymerization may be carried out at a pressure of less than, equal to or greater than 1 atm (absolute). Volatile monomers such as ethylene, butadiene or vinyl chloride are preferably polymerized at elevated pressure. The pressure in the polymerization may be 1.2, 1.5, 2, 5, 10, 15 bar (overpressure) or even higher. If emulsion polymerizations are carried out at reduced pressure, pressures of 950 mbar, commonly of 900 mbar, and often 850 mbar (absolute) are set. Advantageously, the free-radical aqueous emulsion polymerization of the monomers is conducted at 1 atm (=atmospheric pressure=1.013 bar absolute) or under elevated pressure under inert gas atmosphere, for example under nitrogen or argon.

In the free-radically initiated aqueous emulsion polymerization, the aqueous polymerization medium may in principle also comprise minor amounts (<5% by weight) of water-soluble organic solvents, for example methanol, ethanol, isopropanol, butanols, pentanols, but also acetone, etc. Preferably, however, the free-radically initiated aqueous emulsion polymerization is effected in the absence of such solvents.

The polymers P used in accordance with the invention have a glass transition temperature T_{g}≥35° C. and ≤150° C. measured according to DIN EN ISO 11357-2 (2013 September). Advantageously, the glass transition temperature of the polymers P is within a range of ≥40 and ≤110° C. and particularly advantageously within a range of ≥60 and ≤90° C.

A further important point is that, according to Fox (T. G. Fox, Bull. Am. Phys. Soc. 1956 [Ser. II] 1, page 123 and according to Ullmann's Encyclopädie der technischen Chemie [Ullmann's Encyclopedia of Industrial Chemistry], vol. 19, page 18, 4th edition, Verlag Chemie, Weinheim, 1980), the glass transition temperature of at most lightly crosslinked copolymers can be estimated in a good approximation by the following equation:

$$1 / Tg = {x}_{1} / {Tg}^{1} + {x}_{2} / {Tg}^{2} + … + {x}_{n} {Tg}^{n}$$

where x₁, x₂, . . . xₙ are the mass fractions of the monomers 1, 2, . . . n and Tg¹, Tg², . . . Tgⁿ are the glass transition temperatures in degrees kelvin of the homopolymers synthesized from in each case only one of the monomers 1, 2, . . . n. The glass transition temperatures of these homopolymers of most ethylenically unsaturated monomers are known (or can be determined experimentally in a simple manner known per se) and are detailed, for example, in Brandrup, J.; Immergut, E. H.; Grulke, E. A.; Abe, A.; Bloch, D. R.: Polymer Handbook, 4th Edition, Wiley-VCH 2003, and in Penzel, E., Ballard, N. and Asua, J. M. (2021). Polyacrylates. In Ullmann's Encyclopedia of Industrial Chemistry.

The aqueous dispersions of the polymer P obtainable by emulsion polymerization typically have a solids content of ≥30% and ≤70% by weight, frequently ≥40% and ≤68% by weight and often ≥45% and ≤65% by weight, based in each case on the aqueous polymer dispersion.

Particularly advantageously, the polymers P are in the form of particles having an average particle diameter ≥10 and ≤1000 nm, advantageously ≥30 and ≤600 nm and particularly advantageously ≥100 to ≤500 nm, determined by the method of quasielastic light scattering (ISO Standard 13 321; cumulant z-average).

In the production of the polymer/fiber composite, advantageously ≥1 and ≤50 g and particularly advantageously ≥5 and ≤25 g of polymer dispersion P (in solid form) (calculated as the sum total of polymers A or polymer mixture A and the total amount of monomers M), based on 100 g of fibrous substrate, is used.

In order to increase the strength of the composite, but without losing thermoformability, it is possible in a preferred embodiment that the dispersion of polymer P comprises ≤3% by weight, preferably 0.1% to 3% by weight, of an amine having at least 2 hydroxyl groups, based on polymer dispersion P (in solid form).

Suitable amines having at least two hydroxyl groups are secondary or tertiary alkylamines having C₁-C₂₀-alkyl radicals that may optionally be unsaturated and/or interrupted by oxy groups. The amines have two, three or four hydroxyl groups. Advantageously suitable are β-hydroxyalkylamines of the general formula

$${R}^{1} - N - {R}^{2} ( {R}^{3} )$$

in which
R¹ is a hydrogen atom, a C₁- to C₁₀-alkyl group, a C₁-C₁₀-hydroxyalkyl group that may be interrupted by ethylene oxide and/or propylene oxide units, and
R² and R³ are independently a C₁-C₁₀-hydroxyalkyl group.

Particular preference is given to diethanolamine, triethanolamine, diisopropanolamine, triisopropanolamine, especially triethanolamine.

In a further preferred embodiment, the aqueous polymer dispersion P does not comprise any triethanolamine, in particular any amine having at least 2 hydroxyl groups.

By the process of the invention, in particular, polymer/fiber composites having a basis weight of ≥1000 and ≤30 000 g/m², especially advantageously ≥1000 and ≤20 000 g/m² and advantageously ≥1000 and ≤10 000 g/m² are obtainable. In this context, the polymer/fiber composites obtainable by the process of the invention, in a preferred embodiment, are two-dimensional, whereas, in a further preferred embodiment, they have a non-flat three-dimensional structure.

The invention also encompasses the polymer/fiber composites as obtainable by the process of the invention.

In a corresponding manner, the invention also encompasses the use of a polymer/fiber composite of the invention for production of a polymer/fiber molding which differs in shape from the polymer/fiber composite used.

Accordingly, the invention also encompasses a process for producing a polymer/fiber molding, which comprises heating the polymer/fiber composite of the invention up to a temperature≥the glass transition temperature T_{g} of polymer P and converting it to the desired shape of the polymer/fiber molding at a temperature≥the glass transition temperature T_{g} of polymer P and then cooling the resultant polymer/fiber molding down to a temperature<the glass transition temperature T_{g} of polymer P while maintaining its shape.

According to the invention, the polymer/fiber composite is heated up to a temperature corresponding at least to the glass transition temperature T_{g} of polymer P. Advantageously, the polymer/fiber composite is heated up to a temperature T_{g}+≥10 K and particularly advantageously T_{g}+≥30 K, i.e. a temperature at least 10 and preferably 30 kelvin above the glass transition temperature of polymer P.

It is also important that, in one embodiment, the polymer/fiber molding is produced by means of a heated mold press, the contact surface of which has a temperature ≥T_{g} and the shape of which corresponds to the negative mold of the polymer/fiber molding, and said molding is cooled outside the mold press. In this embodiment, the heating operation and forming operation are effected in the heated mold press. It will be appreciated that it is also possible in accordance with the invention that the polymer/fiber composite is heated up to a temperature ≥T_{g} outside the mold press and then formed within the mold press without further heating to give the polymer/fiber molding. In this embodiment, the heating operation and the forming operation are effected separately.

In an advantageous embodiment, the process of the invention is effected in such a way that, before or after the heating operation but before the forming step, an intermediate process step is also conducted in which a two-dimensional decor material is applied to one and/or the other surface of the polymer/fiber composite.

The decor material usable in accordance with the invention is advantageously a textile fabric, for example a nonwoven material, a weave or a knit made from natural or synthetic fibers, a polymer film, for example a thermoplastic polyvinyl chloride, polyolefin or polyester film, a foamed sheetlike material, for example a sheetlike material composed of a polyolefin or polyurethane foam, a foamed sheetlike material which has in turn been coated (laminated) on the surface that does not come into contact with the heated polymer/fiber composite with a textile fabric, a polymer film or a further foamed sheetlike material, or a wood veneer.

The two-dimensional decor material generally has a thickness of ≤10 mm. If the two-dimensional decor material is a textile fabric or a polymer film, the thickness thereof is generally ≤3 mm, frequently advantageously ≤2 mm and frequently especially advantageously ≤1 mm.

If, however, the two-dimensional decor material is a foamed sheetlike material or a coated (laminated) foamed sheetlike material, the thickness thereof is frequently ≤8 mm, often ≤5 mm and particularly often ≤3 mm. If the sheetlike decor material is a wood veneer, however, the thickness thereof is generally ≤3 mm, frequently advantageously ≤2 mm and frequently especially advantageously ≤1 mm.

The invention therefore also encompasses the polymer/fiber moldings obtainable by the aforementioned process.

It is also of significance in accordance with the invention that both the process for production of the polymer/fiber composite and the process for production of the polymer/fiber molding can be effected continuously or batchwise.

The polymer/fiber moldings obtainable in accordance with the invention have good thermal dimensional stability and are therefore advantageously suitable as a component in motor vehicle construction, for example as a door insert, door decor element, knee bolster, glovebox, parcel shelf, sunvisor, center console, rear trunk cladding or seat back cladding, in building materials, for example as a room divider, dividing wall, cover panel or wall decor part, and in furniture as a furniture molding, for example as a seat or backrest surface, particular preference being given to use as a wall decor part, furniture molding or interior component in vehicle construction.

Moreover, the polymer/fiber moldings of the invention have good dimensional stability under moist climatic conditions. They are therefore advantageously suitable as bathroom or kitchen furniture or furniture in general which is exposed to a relatively high load of water vapor, for example in climatic zones with high humidity.

The invention is to be elucidated by nonlimiting examples that follow.

### EXAMPLES

### Test Methods:

The solids content was generally determined with a Mettler Toledo moisture analyzer by drying of 0.5 to 1 g of a polymer dispersion or polymer solution obtained to constant weight at 140° C.

The glass transition temperature of polymer P was generally determined with the aid of a TA Instruments Q 2000 differential calorimeter. The heating rate was 10 K per minute.

The number-average particle size of the dispersion particles was generally determined by dynamic light scattering on a 0.005 to 0.01% by weight aqueous dispersion at 23° C. using an Autosizer IIC from Malvern Instruments, England. What is reported is the cumulant z-average diameter of the measured autocorrelation function (ISO Standard 13321).

The pH values were generally determined by analyzing a sample with a Schott pH electrode at room temperature.

The viscosity was determined by the Brookfield method (ISO 2555, 1989) at 23° C.

The molecular weight of polymer solutions A1, A2 and A3 was determined by gel permeation chromatography via a polyacrylic acid sodium salt as standard using two series-connected Tosoh TSKgel G 3000 PWXL columns at a temperature of 35° C., an eluent (deionized water with 0.01 mol/l phosphate buffer, pH 7.4, and 0.01 mol/l NaN3), a flow rate of 0.5 ml per minute, an injection volume of 100 μl, a concentration of the injected solution of 1 to 2 mg/ml, and a DRI detector from Agilent Technologies GmbH.

Substances used:
Polymer solution A1: 50% by weight aqueous solution of acrylic acid/maleic acid copolymer (acrylic acid/maleic acid weight ratio in the polymer 50:50) having a weight-average molecular weight of 3000 g/mol
Polymer solution A2: 44% by weight aqueous solution of acrylic acid/maleic acid copolymer (acrylic acid/maleic acid weight ratio in the polymer 70:30) having a weight-average molecular weight of 10 000 g/mol
Polymer solution A3: 49% by weight aqueous solution of an acrylic acid homopolymer having a weight-average molecular weight of 5000 g/mol

### Example 1: Production of an Aqueous Polymer P Dispersion in the Presence of a Polymer Mixture A (Dispersion D1)

A 4 l glass vessel with anchor stirrer, reflux condenser and metering device was initially charged at 23° C. with 378 g of deionized water, 792 g of polymer solution A1, and 150 g of polymer solution A2 and 18.6 g of triethanolamine. Polymer mixture A (polymer A1+polymer A2) is thus formed from monomers A1/A2 in a weight ratio of 54/46 (acrylic acid/maleic acid).

66 g of a 25% by weight aqueous sodium hydroxide solution was then added dropwise to this mixture via a dropping funnel, and the mixture was heated up to 94° C. under a nitrogen atmosphere at atmospheric pressure (1.013 bar absolute). On attainment of the temperature, 10 parts by weight of feed 1 was metered in while stirring within one minute. Subsequently, beginning simultaneously with and while maintaining a polymerization temperature of 93° C., the remainder of feed 1 and the entirety of feed 2 were metered in. Feed 1 was metered in over the course of 165 minutes, and feed 2 was metered in continuously over the course of 150 minutes with a constant flow rate.
Feed 1: 220 g of a 7% by weight aqueous solution of sodium peroxodisulfate.
Feed 2: homogeneous emulsion of
   298 g of deionized water,
   27.5 g of a 28% by weight aqueous solution of sodium lauryl ether sulfate (Disponil® FES 27; product from BASF SE),
22 g of a 15% by weight aqueous solution of sodium dodecylsulfate (Disponil® SDS 15; product from BASF SE),
132 g of n-butyl acrylate,
233 g of methyl methacrylate,
702 g of styrene and
33 g of glycidyl methacrylate.

On completion of addition of feed 1, stirring was continued for another 5 minutes while cooling to 90° C. This was followed by stirring at 90° C. for a further 45 minutes. Thereafter, the polymerization mixture was cooled down to room temperature and adjusted to pH 2.8 by dropwise addition of 32 g of a 25% by weight aqueous sodium hydroxide solution.

After filtration through a 125 μm filter, the resultant aqueous polymer dispersion had a solids content of 53.0% by weight and a viscosity of 84 mPas. The number-average particle size was determined as 317 nm and the glass transition temperature of the emulsion polymer as 79° C.

### Example 2: Production of an Aqueous Polymer P Dispersion in the Presence of a Polymer Mixture a (Dispersion D2)

A 4 l glass vessel with anchor stirrer, reflux condenser and metering device was initially charged at 23° C. with 322 g of deionized water, 792 g of polymer solution A1, and 198 g of polymer solution A2.

100 g of a 25% by weight aqueous sodium hydroxide solution was then added dropwise to this polymer mixture A via a dropping funnel, and the mixture was heated up to 94° C. under a nitrogen atmosphere at atmospheric pressure (1.013 bar absolute). The further procedure was as in example 1 with the same feed compositions and feed rates.

After filtration through a 125 μm filter, the resultant aqueous polymer dispersion had a solids content of 53.0% and a viscosity of 106 mPas. The number-average particle size was determined as 325 nm and the glass transition temperature of the emulsion polymer as 78° C.

### Example 3: Production of an Aqueous Polymer P Dispersion in the Presence of Polymer A1 (Dispersion D3)

A 4 l glass vessel with anchor stirrer, reflux condenser and metering device was initially charged at 23° C. with 319 g of deionized water and 595 g of polymer solution A1.

110 g of a 25% by weight aqueous sodium hydroxide solution was then added dropwise to this mixture via a dropping funnel, and the mixture was heated up to 94° C. under a nitrogen atmosphere at atmospheric pressure (1.013 bar absolute). On attainment of the temperature, 10 parts by weight of feed 1 was metered in while stirring within one minute. Subsequently, beginning simultaneously with and while maintaining a polymerization temperature of 93° C., the remainder of feed 1 and the entirety of feed 2 were metered in. Feed 1 was metered in over the course of 165 minutes, and feed 2 was metered in continuously over the course of 150 minutes with a constant flow rate.
Feed 1:180 g of a 7% by weight aqueous solution of sodium peroxodisulfate.
Feed 2: homogeneous emulsion of
   267 g of deionized water,
   21.4 g of a 28% by weight aqueous solution of sodium lauryl ether sulfate (Disponil® FES 27; product from BASF SE),
   16 g of a 15% by weight aqueous solution of sodium dodecylsulfate (Disponil SDS 15; product from BASF SE),
   108 g of n-butyl acrylate,
   199 g of methyl methacrylate and
   596 g of styrene.

On completion of addition of feed 1, stirring was continued for another 5 minutes while cooling to 90° C. This was followed by stirring at 90° C. for a further 45 minutes. Thereafter, the polymerization mixture was cooled down to room temperature and adjusted to pH 2.8 by dropwise addition of 32 g of a 25% by weight aqueous sodium hydroxide solution.

After filtration through a 125 μm filter, the resultant aqueous polymer dispersion had a solids content of 52.5% and a viscosity of 70 mPas. The number-average particle size was determined as 325 nm and the glass transition temperature of the emulsion polymer as 80° C.

### Example 4: Production of an Aqueous Polymer P Dispersion in the Presence of Polymer A3 (Comparative Dispersion V1—Noninventive)

A 4 l glass vessel with anchor stirrer, reflux condenser and metering device was initially charged at 23° C. with 433 g of deionized water and 941 g of polymer solution A3.

96 g of a 25% by weight aqueous sodium hydroxide solution was then added dropwise to this mixture via a dropping funnel, and the mixture was heated up to 94° C. under a nitrogen atmosphere at atmospheric pressure (1.013 bar absolute). On attainment of the temperature, 10 parts by weight of feed 1 was metered in while stirring within one minute. Subsequently, beginning simultaneously with and while maintaining a polymerization temperature of 93° C., the remainder of feed 1 and the entirety of feed 2 were metered in. Feed 1 was metered in over the course of 165 minutes, and feed 2 was metered in continuously over the course of 150 minutes with a constant flow rate.
Feed 1: 160 g of a 7% by weight aqueous solution of sodium peroxodisulfate.
Feed 2: homogeneous emulsion of
292 g of deionized water,
28.6 g of a 28% by weight aqueous solution of sodium lauryl ether sulfate (Disponil® FES 27; product from BASF SE),
21.3 g of a 15% by weight aqueous solution of sodium dodecylsulfate (Disponil® SDS 15; product from BASF SE),
80 g of n-butyl acrylate,
763 g of methyl methacrylate and
277 g of styrene.

On completion of addition of feed 1, stirring was continued for another 5 minutes while cooling to 90° C. Subsequently, the polymerization mixture was stirred at 90° C. for a further 45 minutes and then cooled down to room temperature.

After filtration through a 125 μm filter, the resultant aqueous polymer dispersion had a solids content of 51.9%, a pH of 3.5 and a viscosity of 120 mPas. The number-average particle size was determined as 446 nm and the glass transition temperature of the emulsion polymer as 92° C.

### Example 5: Production of an Aqueous Polymer P Dispersion in the Presence of Polymer A3 (Comparative Dispersion V2—Noninventive)

A 4 l glass vessel with anchor stirrer, reflux condenser and metering device was initially charged at 23° C. with 408 g of deionized water and 1041 g of polymer solution A3.

102 g of a 25% by weight aqueous sodium hydroxide solution was then added dropwise to this mixture via a dropping funnel, and the mixture was heated up to 94° C. under a nitrogen atmosphere at atmospheric pressure (1.013 bar absolute). On attainment of the temperature, 10 parts by weight of feed 1 was metered in while stirring within one minute. Subsequently, beginning simultaneously with and while maintaining a polymerization temperature of 93° C., the remainder of feed 1 and the entirety of feed 2 were metered in. Feed 1 was metered in over the course of 165 minutes, and feed 2 was metered in continuously over the course of 150 minutes with a constant flow rate.
Feed 1: 170 g of a 7% by weight aqueous solution of sodium peroxodisulfate.
Feed 2: homogeneous emulsion of
329 g of deionized water,
30.4 g of a 28% by weight aqueous solution of sodium lauryl ether sulfate (Disponil® FES 27; product from BASF SE),
22.7 g of a 15% by weight aqueous solution of sodium dodecylsulfate (Disponil® SDS 15; product from BASF SE),
85 g of n-butyl acrylate,
621 g of methyl methacrylate and
415 g of styrene.

On completion of addition of feed 1, stirring was continued for another 5 minutes while cooling to 90° C. Subsequently, the polymerization mixture was stirred at 90° C. for a further 45 minutes and then cooled down to room temperature.

After filtration through a 125 μm filter, the resultant aqueous polymer dispersion had a solids content of 52.3%, a pH of 3.5 and a viscosity of 134 mPas. The number-average particle size was determined as 352 nm and the glass transition temperature of the emulsion polymer as 86° C.

### Example 6

In addition, the dispersion of example 3 of WO 01/27163 was reworked (comparative dispersion V3—noninventive).

### General Procedure for Production of Fiberboards (Polymer/Fiber Composite)

The studies were conducted with a 12 inch refiner from Antriz and a blowline connected thereto. The refiner was operated at 160 to 170° C. and an internal pressure of 5 to 6 bar (gauge). The distance between the two grinding plates was 0.3 mm, and one of the grinding plates was operated at 3000 revolutions per minute. The blowline (steel tube) connected to the refiner via a flange had an internal diameter of 3 cm and a tube length of 30 m. Through a 0.2 mm nozzle which was inserted at a distance of 50 cm from the refiner outlet/blowline inlet in the blowline wall, the aqueous binders were then injected into the blowline at 2 bar (gauge). At the end of the blowline was a cyclone separator, by means of which the coated wood fibers were dried further, cooled down to a temperature of about 80° C. and separated out into an open vessel.

For the studies, spruce woodchips that have been pretreated with water/steam at 160 to 170° C. at 5 to 6 bar gauge in a boiler were used, with the mass flow rate of woodchips into the refiner (or wood fibers into the blowline) set at 30 kg per hour.

The binders used were dispersions D1, D2 and D3, and comparative dispersions V1, V2 and V3. The binders were injected into the blowline through the 0.2 mm nozzle by means of an eccentric screw pump at a pressure of 2 bar (gauge), with the mass flow rates adjusted in each case to 4.8 kg of binder (calculated as solids) per hour. There was a test for each binder over 2 hours in the continuous steady state, with collection of the wood fibers sprayed with the respective binder over the course of this time in the open vessel. The proportion of polymer P (in solid form) based on the fibers is 15% by weight.

The “glued” fibers obtained from the blowline according to the aforementioned test procedure were respectively used to produce 2 semifinished products of thickness 8.5 mm and length×width 22×22 cm with a target density of 0.65 g/cm³. For this purpose, 268 g of the fibers obtained (residual moisture content about 8% by weight based on dry fibers, average fiber length about 2 mm, average fiber thickness about 0.4 mm) was scattered homogeneously into a horizontal wooden frame with internal dimensions of 22×22×30 cm (L/W/H). Thereafter, a 22×22 cm wooden board was placed horizontally onto the fiber web present within the wooden frame and the fiber web was subjected to preliminary compaction to a height of 5 cm with a ram in the middle. The fiber cake thus obtained was then removed from the wooden frame, covered with a release paper on the two square faces and compressed to a thickness of 8.5 mm at 180° C. under pressure with a compression time factor of 12 seconds per millimeter of composite thickness. Thereafter, the fiberboards obtained were left to cool down to room temperature outside the press. These fiberboards (polymer/fiber composite) serve as semifinished products for subsequent consolidation at one 140° C. or 180° C. with a compression time factor of 12 seconds per millimeter of shaped body thickness in order to simulate a downstream deformation and to test water stability and other parameters on the “shaped bodies” thus obtained.

The shaped bodies thus obtained, depending on the binder used, are called FPD1 (fiberboard with dispersion D1), FPD2 (fiberboard with dispersion D2), FPD3 (fiberboard with dispersion D3), FPV1 (fiberboard with comparative dispersion V1), FPV2 (fiberboard with comparative dispersion V2) and FPV3.

### Performance Testing

### Determination of Water Stability and Mechanical Indices:

The semifinished products obtained, after storage under standard climatic conditions for 24 hours, are subjected to a further consolidation (corresponding to a forming operation) at 140° C. and at 180° C. The semifinished products with a density of 0.65 g/cm³ are postconsolidated here to a density of 0.90 g/cm³.

The fiberboards (shaped bodies) obtained (polymer content 15% by weight based on the fiberboard) are stored at 20° C./65% relative humidity under standard climatic conditions for 24 hours and then tested. Water absorption and thickness swelling are determined by cutting out 5×5 cm specimens and determining the thicknesses of the boards to DIN EN 325 with a measuring instrument in the middle of the square sample surface to an accuracy of 0.01 mm. The density of the boards is determined by the ratio of the mass of the fiberboards to their volume, which can in turn be ascertained from length, width and thickness of the fiberboards. The water absorption of the wood fiberboards is determined as the relative increase in weight, and the thickness swelling as the relative increase in thickness, of 5×5 cm specimens after storage in demineralized water for 24 h in accordance with DIN EN 317. Flexural modulus of elasticity and flexural strength at 23° C. are measured by a three-point bending test to DIN EN 310.

TABLE 1
Results of the tests on the shaped bodies compressed at 140° C.
from glued wood fibers with the binders from D1, D2, D3, V1, V2 and V3

| Shaped bodies | FPD1 | FPD2 | FPD3 | FPV1 | FPV2 | FPV3 |
|---|---|---|---|---|---|---|
| Binder | D1 | D2 | D3 | V1 | V2 | V3 |
| Board | 6.00 | 6.20 | 6.03 | 5.98 | 6.00 | 6.10 |
| thickness | | | | | | |
| [mm] | | | | | | |
| Density | 0.85 | 0.86 | 0.83 | 0.85 | 0.82 | 0.83 |
| [g/cm³] | | | | | | |
| Water | 29 | 27 | 31 | 29 | 18 | 21 |
| absorption | | | | | | |
| after 2 h [%] | | | | | | |
| Standard | 2 | 2 | 2 | 2 | 1 | 1 |
| deviation | | | | | | |
| Water absorption | 124 | 112 | 130 | 145 | 152 | 240 |
| after 24 h [%] | | | | | | |
| Standard | 5 | 4 | 6 | 9 | 11 | 15 |
| deviation | | | | | | |
| [%] | | | | | | |
| Thickness | 16 | 17 | 15 | 16 | 10 | 9 |
| swelling | | | | | | |
| after 2 h [%] | | | | | | |
| Standard | 1 | 1 | 1 | 1 | 0 | 1 |
| deviation | | | | | | |
| [%] | | | | | | |
| Thickness | 54 | 55 | 58 | 124 | 135 | 187 |
| swelling | | | | | | |
| after 24 h [%] | | | | | | |
| Standard | 3 | 2 | 3 | 10 | 12 | 17 |
| deviation | | | | | | |
| [%] | | | | | | |
| Flexural modulus | 2859 | 2932 | 2786 | 2859 | 3393 | 2687 |
| of elasticity ISO | | | | | | |
| 178 [N/mm²] | | | | | | |
| Standard | 81 | 78 | 92 | 101 | 106 | 171 |
| deviation | | | | | | |
| [N/mm²] | | | | | | |
| Flexural strength | 27 | 28 | 25 | 27 | 37 | 29 |
| [N/mm²] | | | | | | |
| Standard | 2 | 2 | 3 | 2 | 3 | 4 |
| deviation | | | | | | |
| [N/mm²] | | | | | | |
| Width [mm] | 15.2 | 15.1 | 15.3 | 15.2 | 15.1 | 14.9 |
| Span [mm] | 78 | 78 | 78 | 78 | 78 | 78 |

TABLE 2
Results of the tests on the comparative boards (shaped
bodies) produced, compressed at 180° C. from glued
wood fibers with the binders from D1, D2, D3, V1, V2 and V3

| Shaped bodies | FPD1 | FPD2 | FPD3 | FPV1 | FPV2 | FPV3 |
|---|---|---|---|---|---|---|
| Binder | D1 | D2 | D3 | V1 | V2 | V3 |
| Board | 6.0 | 6.0 | 6.03 | 6.03 | 5.98 | 6.2 |
| thickness | | | | | | |
| [mm] | | | | | | |
| Density | 0.84 | 0.85 | 0.84 | 0.86 | 0.83 | 0.83 |
| [g/cm³] | | | | | | |
| Water absorption | 21 | 24 | 25 | 29 | 27 | 35 |
| after 2 h [%] | | | | | | |
| Standard | 1 | 1 | 3 | 2 | 1 | 2 |
| deviation | | | | | | |
| Water absorption | 74 | 71 | 87 | 124 | 129 | 112 |
| after 24 h [%] | | | | | | |
| Standard | 3 | 8 | 6 | 5 | 7 | 10 |
| deviation | | | | | | |
| [%] | | | | | | |
| Thickness | 9 | 10 | 12 | 22 | 24 | 18 |
| swelling | | | | | | |
| after 2 h [%] | | | | | | |
| Standard | 8 | 0 | 6 | 1 | 0 | 1 |
| deviation | | | | | | |
| [%] | | | | | | |
| Thickness | 33 | 35 | 38 | 87 | 90 | 56 |
| swelling | | | | | | |
| after 24 h [%] | | | | | | |
| Standard | 1 | 4 | 2 | 3 | 6 | 2 |
| deviation | | | | | | |
| [%] | | | | | | |
| Flexural | 853 | 961 | 2744 | 2859 | 3393 | 2687 |
| modulus of | | | | | | |
| elasticity ISO 178 | | | | | | |
| [N/mm²] | | | | | | |
| Standard | 86 | 79 | 74 | 81 | 106 | 171 |
| deviation | | | | | | |
| [N/mm²] | | | | | | |
| Flexural strength | 30 | 32 | 28 | 28 | 27 | 35 |
| [N/mm²] | | | | | | |
| Standard | 1 | 1 | 1 | 2 | 3 | 4 |
| deviation | | | | | | |
| [N/mm²] | | | | | | |
| Width [mm] | 15.1 | 15 | 15.4 | 15.2 | 15.1 | 14.9 |
| Span [mm] | 78 | 78 | 78 | 78 | 78 | 78 |

In the case of FPV3, it is apparent that it is only at higher temperatures, 180° C. compared to 140° C., that the crosslinking of the system leads to an improvement in water stability. The inventive examples, by contrast, even at low temperatures have lower values for water absorption and thickness swelling. Although the comparative binders V1 and V2 are poorer at 140° C. and improve with increasing temperature, they do not reach the level of the inventive examples.

1.-18. (canceled)

19. A process for producing a thermoformable polymer/fiber composite using a polymer P and a fibrous substrate, where the latter are particles having a ratio of their longest extent to their shortest extent of at least 3, where
the fibrous substrate is introduced into a gas stream, then
the fibrous substrate in the gas stream is contacted with an aqueous dispersion of a polymer P having a glass transition temperature T_{g}≥35 and ≤150° C. measured to DIN EN ISO 11357-2 (2013 September), then
the fibrous substrate that has been contacted with the aqueous dispersion of the polymer P is dried in the gas stream and then deposited, then
the deposited fibrous substrate obtained is converted to a fiber web, and then
the resultant fiber web is consolidated at a temperature≥the glass transition temperature Tg of polymer P to give the polymer/fiber composite, where the density of the polymer/fiber composite is increased by a factor of ≥3 compared to the corresponding fiber web,
wherein the aqueous dispersion of the polymer P is obtained by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (M2), and
0% to 10% by weight of at least one further ethylenically unsaturated compound (M3) which is copolymerizable with monomers M1 and M2,
based in each case on the total amount of the monomers M,
in an aqueous medium in the presence of a polymer A or a polymer mixture A, where polymer A or polymer mixture A is formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amounts of monomers A add up to 100% by weight,
with the proviso that neither polymer A nor polymer mixture A is formed from an ester selected from the esters of ethylenically unsaturated monocarboxylic acids with amines having at least two hydroxyl groups, the monoesters and the diesters of ethylenically unsaturated dicarboxylic acids with amines having at least two hydroxyl groups.

20. The process according to claim 19, wherein the fibrous substrate used is a natural fiber.

21. The process according to claim 19, wherein polymer A has a weight-average molecular weight Mw of ≥1000 and ≤20 000 g/mol.

22. The process according to claim 19, wherein the aqueous dispersion of polymer P is obtained by free-radically initiated emulsion polymerization in an aqueous medium in the presence of a polymer mixture A, where the polymer mixture A comprises
10% to 30% by weight of a polymer A1 having a weight-average molecular weight of ≥7000 and ≤20 000 g/mol and
70% to 90% by weight of a polymer A2 having a weight-average molecular weight of ≥1000 and ≤5000 g/mol,
based on the total amount of polymer mixture A.

23. The process according to claim 19, wherein the ratio of the amount of polymer A to the total amount of monomers M is in the range from 10:90 to 50:50, and that of polymer mixture A to the total amount of monomers M is in the range from 10:90 to 50:50.

24. The process according to claim 19, wherein the glass transition temperature of polymer P is ≥60° C. and ≤150° C.

25. The process according to claim 19, wherein the aqueous dispersion of polymer P is obtainable by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 94.9% by weight of styrene and/or methyl methacrylate (M2),
0.1% to 10% by weight of at least one further ethylenically unsaturated compound (M3) which is copolymerizable with monomers M1 and M2, of which 0.1% to 5.0% by weight, based on total monomers M, is glycidyl acrylate and/or glycidyl methacrylate,
based in each case on the total amount of the monomers M.

26. The process according to claim 19, wherein the aqueous dispersion of polymer P is obtainable by free-radically initiated emulsion polymerization of a monomer composition composed of
5% to 20% by weight of ethyl acrylate, propyl acrylate, n-butyl acrylate, i-butyl acrylate, hexyl acrylate and/or 2-ethylhexyl acrylate,
70% to 94.9% by weight of styrene and/or methyl methacrylate,
0.1% to 5.0% by weight of glycidyl acrylate and/or glycidyl methacrylate,
0% to 5.0% by weight of acrylic acid, methacrylic acid, 2-hydroxyethyl acrylate, 2-hydroxypropyl acrylate and/or 3-hydroxypropyl acrylate and/or 2-hydroxyethyl methacrylate, 2-hydroxypropyl methacrylate and/or 3-hydroxypropyl methacrylate,
0% to 2.0% by weight of 1,4-butylene glycol diacrylate, 1,4-butylene glycol dimethacrylate, 1,2-, 1,3- and/or 1,4-divinylbenzene, allyl acrylate and/or allyl methacrylate,
based in each case on the total amount of the monomers M.

27. The process according to claim 19, wherein the dispersion of polymer P comprises ≤3% by weight of an amine having at least two hydroxyl groups based on the sum total of polymer A and total monomers M or based on the sum total of polymer mixture A and total monomers M.

28. The process according to claim 19, wherein the thermoformable polymer/fiber composite obtained has a basis weight of ≥1000 and ≤30 000 g/m².

29. The process according to claim 19, wherein the thermoformable polymer/fiber composite obtained is two-dimensional.

30. A thermoformable polymer/fiber composite obtainable by a process according to claim 19.

31. The use of the thermoformable polymer/fiber composite according to claim 30 for production of a polymer/fiber molding which differs in shape from the polymer/fiber composite used.

32. A process for producing a polymer/fiber molding, which comprises heating the thermoformable polymer/fiber composite according to claim 30 up to a temperature≥the glass transition temperature T_{g} of polymer P and converting it to the desired shape of the polymer/fiber molding at a temperature≥the glass transition temperature T_{g} of polymer P and then cooling the resultant polymer/fiber molding down to a temperature<the glass transition temperature T_{g} of polymer P while maintaining its shape.

33. A polymer/fiber molding obtainable by a process according to claim 32.

34. The use of a polymer/fiber molding according to claim 33 as a furniture molding, wall decor part or interior component in vehicle construction.

35. A process for producing an aqueous dispersion of polymer P according to claim 19 by free-radically initiated emulsion polymerization of a monomer composition composed of
5% to 30% by weight of one or more monomers M1 selected from esters of acrylic and/or methacrylic acid with alkanols having 2 to 8 carbon atoms,
70% to 95% by weight of styrene and/or methyl methacrylate (M2), and
0% to 10% by weight of at least one further ethylenically unsaturated compound (M3) which is copolymerizable with monomers M1 and M2,
based in each case on the total amount of the monomers M,
in an aqueous medium in the presence of a polymer A or a polymer mixture A, where polymer A or polymer mixture A is formed from
40% to 70% by weight of acrylic acid (monomer A1),
30% to 60% by weight of maleic acid and/or maleic anhydride (monomer A2),
0% to 5% by weight of at least one further ethylenically unsaturated compound which is copolymerizable with monomers A1 and A2 (monomer A3),
and where the total amounts of monomers A add up to 100% by weight,
with the proviso that neither polymer A nor polymer mixture A is formed from an ester selected from the esters of ethylenically unsaturated monocarboxylic acids with amines having at least two hydroxyl groups, the monoesters and the diesters of ethylenically unsaturated dicarboxylic acids with amines having at least two hydroxyl groups.

36. An aqueous dispersion of polymer P obtainable by a process according to claim 35.
